(19) United States
(12) Patent Application Publication
(10) Pub. No.: US 2015/0141251 A1
(43) Pub. Date: May 21, 2015

(54) SPONTANEOUS SELF-FORMING MIXED SURFACTANT NANO-EMULSIONS FROM WATER INSOLUBLE PESTICIDES IN MIXED WATER MISCIBLE SOLVENTS

(71) Applicants: Howard Bernard DAWSON, Hampshire (GB); Rachel BRANAGHAN, Hampshire (GB); Eric James MCEWEN, Westwood Hill, KS (US); Sandra ALCARAZ, Yuma, AZ (US); Tak Wai CHEUNG, Mountain House, CA (US)

(72) Inventors: Howard Bernard DAWSON, Hampshire (GB); Rachel BRANAGHAN, Hampshire (GB); Eric James MCEWEN, Westwood Hill, KS (US); Sandra ALCARAZ, Yuma, AZ (US); Tak Wai CHEUNG, Mountain House, CA (US)

(73) Assignee: GOWAN COMERCIO INTERNACIONAL E SERVICOS LIMIADA, Funchal (PT)

(21) Appl. No.: 14/054,141

(22) Filed: Oct. 15, 2013

Related U.S. Application Data
(60) Provisional application No. 61/713,685, filed on Oct. 15, 2012.

(51) Int. Cl. A01N 25/04; A01N 25/30; A01N 57/16

(52) U.S. Cl. CPC A01N 25/04; A01N 57/16; A01N 25/30
USPC 504/153; 424/405; 514/91; 504/195

(57) ABSTRACT

The present disclosure relates to a pesticidal formulation including i) at least one pesticide, typically an organophosphate compound in an amount between 5.0% w/w and 40.0% w/w, preferably between 15.0% w/w and 30.0% w/w, ii) Solvent system comprising at least one glycol ether and at least one lactone in an amount between 10.0% to 80.0% w/w, preferably between 30.0% w/w and 55% w/w, with ratio of the glycol ether and the lactone is the in the range of 1:9 and 9:1, preferably in the range of 2:8 and 4:6, iii) Surfactant system containing at least two nonionic surfactants where the primary surfactant has an HLB range of 10 to 20 and the co-surfactant has a HLB range 1 to 5, in an amount ranging between 0.1% w/w to 60.0% w/w preferably in the range of 20.0% w/w to 40.0% w/w, and iv) at least one excipient in the range of 0.1% w/w to 10% w/w and preferably 0.5% w/w to 5.0% w/w.

### FIELD OF THE DISCLOSURE

This invention relates to the formation of stable solubilised clear-translucent nano-emulsions created by the dilution of concentrated pesticide formulations in water that use, surprisingly, a combination of at least two water soluble solvent components in a blend that is tailored to the active ingredient in question. Key to the formation of the stable nano-emulsions is the manipulation of a surfactant system that matches the requirements of the pesticide-solvent system.

### BACKGROUND

Each year pests, including insects, cause significant damage to property, crops and plants. Insects are documented to vector diseases, disrupt crop pollination, reduce crop quality and final yield.

Pesticides and insecticides are used to control pests and insects. However, the extensive use of insecticides has resulted in a large number of problems which include insect resistance.

Further, active substances for plant protection are generally not used in their pure form. Depending on the field of application and the type of application, and on physical, chemical and biological parameters, the active substance is used in a mixture with adjuvants, solvents and additives. The various forms of formulation known in the prior art include solutions, emulsifiable concentrates, dispersions, powders, pastes, capsule suspension and the like.

These forms of the formulation known in the art use more quantity of organic solvent and have low disparity, wettability and penetration properties of the pesticide.

### OBJECTS OF THE DISCLOSURE

Some of the objects of the present disclosure, which at least one embodiment herein satisfies, are as follows:

It is an object of the present disclosure to provide a pesticidal formulation.

It is an object of the present disclosure to provide a method of solubilizing a water insoluble active ingredient in a mixed water miscible solvent system and a surfactant system comprising of at least two surfactants. Other components may be included to provide specific properties.

It is an object of the present disclosure a nano-emulsion containing one or more water insoluble active ingredients. The, one or each active ingredient is preferably a biologically active ingredient and may comprise one or more of an insecticide, fungicide, herbicide or miticide.

It is an object of the present disclosure to comprise a formulation contain an active ingredient may comprise an insecticide.

It is an object of the present disclosure to comprise a formulation contain an active ingredient may comprise an herbicide.

It is an object of the present disclosure to comprise a formulation contain an active ingredient may comprise an fungicide.

It is an object of the present disclosure to comprise a formulation contain an active ingredient may comprise a miticide.

It is an object of the present disclosure to provide a formulation, wherein the water miscible solvent system is comprised of at least two solvents one whose primary function is to provide solvency for the active ingredient(s) whilst the other acts as a solubilizer upon dilution with water. The choice and ratio of these two solvents will vary with the physio-chemical properties of the active ingredient(s).

It is an object of the present disclosure to provide a formulation, wherein the surfactant system is comprised of at least two surfactants one of which is water insoluble and the other is water soluble. The choice and ratio of the surfactants will vary with the physio-chemical properties of the active ingredient(s) and the solvent blend used.

It is an object of the present disclosure to provide a pesticidal formulation with a high levels of active ingredient can be incorporated into a system that when diluted in water to product stable, clear-translucent nano-emulsions. Such nano-emulsions have no tendency to phase separate across a broad range of water temperatures (typically 5-30° C.) and hardness (typically 0-1000 ppm Calcium Carbonate).

It is an object of the present disclosure to provide a formulation wherein the ratios of the two water miscible solvents and the surfactant blend used prevent any crystallization of the water insoluble active ingredient(s) when the concentrates are diluted in water at their typical in use rates.

It is another object of the present disclosure to provide a pesticidal formulation which is highly effective against a variety of pests at lower rates comparable to other formulation options.

It is still another object of the present disclosure to provide a pesticidal formulation which is chemically stable.

It is still another object of the present disclosure to provide a pesticidal formulation which is physically stable.

It is still another object of the present disclosure to provide a pesticidal formulation which provides long lasting effect.

It is still another object of this present disclosure to provide a pesticide formulation which has enhanced rate of controlling pests.

It is still another object of this present disclosure to provide a pesticide formulation which has performance equal to standard treatments at rates which are a fraction of standard.

It is still another object of this present disclosure to provide a pesticide nano-emulsion formulation which has increased level of control in reduced time.

### DEFINITION

By the term “surfactant” it is understood that wetting agents, dispersing agents, suspending agents and emulsifiers are included therein. Anionic, nonionic and amphoteric agents and mixtures thereof can also be used. By the term “HLB” it is understood that the hydrophilic lyophilic balance of nonionic surfactants, which is a measure of water solubility. Such that low HLB surfactants 1-5 are water insoluble and high TILE surfactants are 10 to 20 are water soluble, and intermediate HLB surfactants are 6 to 9 have variable water solubility.

### SUMMARY

In accordance with one aspect of the present disclosure there is provided a pesticidal formulation comprising:
i. At least one pesticide, typically an organophosphate compound in an amount between 5.0% w/w and 40.0% w/w, preferably between 15.0% w/w and 30.0% w/w,
ii. Solvent system comprising at least one glycol ether and at least one lactone in an amount between 10.0% to 80.0% w/w, preferably between 30.0% w/w and 55.0% w/w, with ratio of the glycol ether and the lactone is the in the range of 1:9 and 9:1, preferably in the range of 2:8 and 4:6,
iii. Surfactant system containing at least two nonionic surfactants where the primary surfactant has an HLB range of 10 to 20 and the co-surfactant has a HLB range 1 to 5, in an amount ranging between 0.1% w/w to 60.0% w/w preferably in the range of 20.0% w/w to 40.0% w/w, and
iv. At least one excipient in the range of 0.1% w/w to 10.0% w/w and preferably 0.5% w/w to 5.0% w/w.

Typically, the formulation is in the form of a concentrate containing one or more biologically active ingredient(s) which upon dilution spontaneously self-forms a water external nano-emulsion wherein, the particle size of said nano emulsion ranges between 10 to 200 nm.

Typically, the pesticide is at least one selected from the group consisting of algaecide, acaricide, avacide, bactericide, biocide, culicide, fungicide, germicide, gonocide, herbicide, insecticide, larvicide, microbicide, muscicide, nemacide, ovacide, parasiticide, pediculicide, pulicicide, raticide, scabicide, spermicide, teniacide, vermicide, vespacide, virucide and miticide, typically an organophosphate, and preferably phosmet in an amount ranging between 5.0 w/w % and 40.0 w/w %, preferably between 15.0 w/w % and 30.0 w/w %.

Further, typically, the pesticide is at least one organophosphate selected from the group consisting of acephate, acethion, acetophos, amiton, amidithion, azamethiphos, azinphos ethyl, azinphos methyl, azothoate, bansulide, bromfenvinfos, bromophos, bromophos-ethyl, butathiofos, carbophenothion, cadusafos, calvinphos, chlorethoxyfos, chlorfenvinphos, chlormephos, chlorpyrifos, chlorpyrifos-methyl, chlorthiophos, chlorphoxim, colophonate, coumaphos, coumithoate, crotoxyphos, cyanophos, cyanthoate, demephion-O, demephion-S, demeton-O, demeton-S, demeton-methyl, demeton-O-methyl, demeton-S-methyl, demeton-S-methylsulphon, dichlorvos, dialifos, diazinon, dicapthon, dichlofenthion, dicrotophos, dimethoate, dimethylvinphos, dioxathion, dioxabenzofos, disulfoton, dithicrofos, endothion, etaphos, ethion, ethoprop, ethyl-parathion, ethoate-methyl, etrimfos, famphur, fenchlorphos, fenamiphos, fenitrothion, fensulfothion, fenthion, fenthion-ethyl, fonofos, fospirate, formothion, heptenophos, heterophos, isazophos, isofenphos, isoxathion, S-ethylsulfinylmethyl O,O-diisopropylphosphorodithioate, isothioate, jodfenphos, lirimfos, malathion, mecarbam, mesulfenfos, menazon, methacrifos, methylacetophos, methamidophos, methidathion, methyl-parathion, mevinphos, methocrotophos, monocrotophos, morphothion, naled, naftalofos, oxydemeton-methyl, omethoate, parathion, pirimiphos-ethyl, pirimiphos-methyl, phenthoate, phenkapton, phosnichlor, phorate, phosalone, phosmet, phosphamidon, phostebupirim, phoxim, phoxim-methyl, primidophos, profenofos, propaphos, propetamphos, prothiofos, prothoate, pyraclofos, pyrazophos, pyrazothion, pyridaphenthion, pyrimitate, quinothion, quinalphos, quinalphos-methyl, oxydemeton-methyl, oxydeprofos, oxydisulfoton, sophamide, sulfotep, sulprofos, tebupirimfos, temephos, terbufos, tetrachlorvinphos, tetraethyl pyrophosphate, thicrofos, thiometon, trifenofos, vamidothion, xiaochongliulin, zolaprofos, preferably phosmet in an amount ranging between 5.0 w/w % and 40.0 w/w %, preferably between 15.0 w/w % and 30.0 w/w %.

Typically, the nonionic surfactant is at least two selected from the group consisting of ethoxylated alcohols, ethoxylated fatty acid ester, alkoxy block copolymers, alkylpolyglycosides, alkoxylated alkanolaminedes, amine oxide selected from the group consisting of alkyl di(lower alkyl) amine oxides, alkyl di(hydroxy lower alkyl) amine oxides, alkylamidopropyl di(lower alkyl) amine oxides and alkylmorpholine oxides, in an amount ranging between 0.1% w/w and 60.0% w/w, preferably 20.0% w/w and 40.0% w/w.

Typically, the ethoxylated alcohol is selected from one containing C9 to C15 and 3 to 20 moles ethylene oxide in an amount containing between 0.2% w/w and 20.0% w/w, preferably 0.5% w/w and 10.0% w/w.

Preferably, the ethoxylated fatty acid ester is based on ester of sorbitol and fatty acid C10 to C18 with 3 to 25 moles of ethylene oxide.

Typically, the alkoxy block copolymer is at least one selected from the group consisting of ethoxy/propoxy block copolymers and ethoxy/butoxy block copolymers, preferably ethoxy/propoxy block copolymer containing 10.0% to 80.0% ethylene oxide with a propylene oxide backbone of molecular weight of 950 to 3750.

Typically, the hydrophilic-lipophilic balance (HLB) of the primary nonionic surfactant is 10 to 20 and the hydrophilic-lipophilic balance value of the nonionic co-surfactant is between 1 and 5.

Typically, the solvent system further comprises at least an additional solvent selected from the group consisting of methanol, ethanol, butanol, propanol, glycols, glycol ether, cyclohexanone, acetone, acetonitrile, isophorone, esters, ketones and lactones.

Typically, the glycol ether is at least one selected from the group consisting of diethylene glycol-n-butyl ether acetate, diethylene glycol mono butyl ether (butyl carbitol), ethylene glycol n-butyl ether acetate, ethylene glycol mono butyl ether, diethylene glycol monoethyl ether, ethylene glycol phenyl ether, triethylene glycol monoethyl ether, diethylene glycol mono hexyl ether, ethylene glycol mono hexyl ether, triethylene glycol mono methyl ether, diethylene glycol mono methyl ether, ethylene glycol mono-n-propyl ether, dipropylene glycol methyl ether, dipropylene glycol methyl ether acetate, dipropylene glycol-n-butyl ether, dipropylene glycol-n-propyl ether, propylene glycol methyl ether, propylene glycol methyl ether acetate, propylene glycol-n-butyl ether, propylene glycol-n-propyl ether, propylene glycol phenyl ether, tripropylene glycol methyl ether, tripropylene glycol-n-butyl ether and dipropylene glycol dimethyl ether.

Typically, the lactone is at least one selected from the group consisting of α-acetolactone, propiolactone, butyrolactone, d-glucono-lactone, caprolactone, δ-valerolactone, C1 to C10 alkyl substituted linear or branched 3,6-dihydro-2H-Pyran-2-one, 6,7-Dihydro-2(3H)-oxepinone, oxepan-2-one, 2-oxocanone, 2-oxonanone and oxecan-2-one.

Preferably, the amount of said solvent system ranges between 10.0 w/w % and 80.0 w/w %, preferably 30.0 w/w % and 55.0 w/w %.

Typically, the glycol ether and the lactone are in a ratio of 1:9 and 9:1, preferably 2:8 and 4:6.

Typically, the excipient is at least one selected from the group consisting of an anionic surfactant, pH modifiers, preservatives, adjuvants, antifreezes, oils, waxes, thickening agents (gelling agent), emollients, alkalizing agents, acidifying agents, perfumes, binding agents, defoamers, stabilizing agents, dispersing agents, wetting agents, colorants, plant growth regulators and emulsifiers, in a range between 0.1% w/w and 10.0% w/w, preferably 0.5% and 5.0%.

Typically, the anionic surfactant is at least one selected from the group consisting of alkali metal salts, ammonium salts, amine salts, and amino alcohol salts of at least one selected from the group consisting of (linear and secondary) alcohol sulfates and sulfonates, alcohol phosphates and phosphonates, alkyl sulfates, alkyl ether sulfates, sulfate esters of an alkylphenoxy polyoxyethylene ethanol, alkyl monoglyceride sulfates, alkyl sulfonates, olefin sulfonates, paraffin sulfonates, beta-alkoxy alkane sulfonates, alkylamidoether sulfates, alkylaryl polyether sulfates, monoglyceride sulfates, alkyl ether sulfonates, ethoxylated alkyl sulfonates, alkylaryl sulfonates, alkyl benzene sulfonates, alkyl benzene sulfonic acids, alkylamide sulfonates, alkyl monoglyceride sulfonates, alkyl carboxylates, alkyl sulfoacetates, alkyl ether carboxylates, alkyl alkoxy carboxylates having 1 to 5 moles of ethylene oxide, alkyl sulfosuccinates, alkyl ether sulfosuccinates, alkylamide sulfosuccinates, alkyl sulfosuccinamates, octoxynol or nonoxynol phosphates, alkyl phosphates, alkyl ether phosphates, taurates, N-acyl taurates, fatty taurides, fatty acid amide polyoxyethylene sulfates, isethionates, acyl isethionates, and sarcosinates and acyl sarcosinates preferably, alkyl benzene sulfonates represented by a Formula (I) and alkyl benzene sulfonic acids;

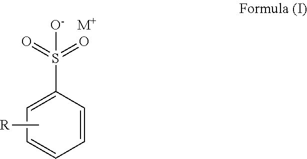

wherein, R is a linear or branched, substituted or unsubstituted, aliphatic or aromatic C8 to C18 carbon atoms, preferably dodecyl, and M is a cation selected from the group consisting of alkali metal, ammonium, amine and amino alcohol, in an amount ranging between 0.1 w/w % and 10.0 w/w %, preferably 0.5 w/w % and 5.0 w/w %.

In accordance with one embodiment of the invention, the formulation comprises 22.0 to 27.0 w/w % of phosmet, 1.0 w/w % of Dodecylbenzenesulfonic acid, 23.0 to 25 w/w % of Butyrolactone, 12.50 w/w % of diethylene glycol mono butyl ether (butyl carbitol), 29.03 w/w % of block copolymer with 10% ethylene oxide [Synperonic PE L/101], 3.32 w/w % of block copolymer with 40% ethylene oxide [Pluronic PE 10400] and 4.15 w/w % of alcohol ethoxylate with C9 to C11 with 5 moles ethylene oxide [Neodol 91-5].

In accordance with another aspect of the invention, it relates to the use of the formulation, as disclosed hereinabove, for controlling a wide variety of insect pests on crops, vegetables, fruits, nuts, turfs, ornamental plants, perennial plants, annuals plants selected from the group consisting of pome fruits which include pear, apple, crabapple, loquat, mayhew and quince, stone fruits which include apricots, cherries, nectarines, peaches, plums, plum cot and prune, olive, canola which include oilseed rape, citrus fruits which include orange, grapefruit, lemon, line and tangerine, bush berries, blueberries, cranberries, potatoes and sweet potatoes, tree nuts which include almonds, sweet almonds, beechnut, brazil nut, butternut, cashew nut, chinquapin, filbert (hazelnut), hickory, macadamia, pecan, pistachio and walnut, alfalfa, grapes, tomato, lettuce, onion, bulb vegetables, cole crops, cucurbits, legume vegetables, root and tuber vegetables, cereal grain, cotton, herbs and tobacco.

Further, the invention also relates to the use said formulation in controlling at least one pest selected from the group consisting of alfalfa weevil, apple maggot, banded grape bug, black pecan aphid, blueberry maggot, cherry fruit flies, codling moth, Colorado potato beetle, dock sawfly, elm spanworm, European corn borer, European sawfly, fire worms, fruit worms, grape berry moth, grape cane borer, grape leaf folder, green fruit worm, gypsy moth, hickory shuck worm, Japanese beetle, leafhoppers, leaf roller, lygocoris bug, mealy bug, navel orange worm, orange tortix, oriental fruit moth, peach twig borer, pecan nut casebearer, pine tip moth, plum curculio, red humped caterpillar, rose chafer, sawfly, scale, spanworm, spotted wing drosophila, strawberry root weevil adult, syneta beetle, walnut husk fly, weevil, western grape leaf skeletonizer, western tussock moth, black cherry aphid, mites, pear psylla, aphids, white fly, thrips and asian citrus psyllid.

In accordance with another aspect of the invention, it discloses a method of controlling a pest selected from the group consisting of alfalfa weevil, apple maggot, banded grape bug, black pecan aphid, blueberry maggot, cherry fruit flies, codling moth, Colorado potato beetle, dock sawfly, elm spanworm, European corn borer, European sawfly, fire worms, fruit worms, grape berry moth, grape cane borer, grape leaf folder, green fruit worm, gypsy moth, hickory shuck worm, Japanese beetle, leafhoppers, leaf roller, lygocoris bug, mealy bug, navel orange worm, orange tortix, oriental fruit moth, peach twig borer, pecan nut casebearer, pine tip moth, plum curculio, red humped caterpillar, rose chafer, sawfly, scale, spanworm, spotted wing drosophila, strawberry root weevil adult, syneta beetle, walnut husk fly, weevil, western grape leaf skeletonizer, western tussock moth, black cherry aphid, mites, pear psylla, aphids, white fly, thrips and asian citrus psyllid, said method comprising the step of applying the pesticidal formulation comprising at least one organophosphate compound in an amount ranging between 15.0 w/w % and 30.0 w/w %, at least one anionic surfactant excipient in an amount ranging between 0.5 w/w % and 5.0 w/w %, a mixture of at least two nonionic surfactants in an amount ranging between 20.0 w/w % and 40.0 w/w %, a solvent system comprising at least one glycol ether and at least one lactone in an amount ranging between 10.0 w/w % and 80.0 w/w %, and optionally, water, using at least one technique selected from the group consisting of spraying, pouring, dipping, rubbing, air-blasting, mist-blowing and oiling to an area infected by said pest.

### BRIEF DESCRIPTION OF THE ACCOMPANYING DRAWINGS

The disclosure will now be explained in relation to the accompanying drawings, in which:

FIG. 1 illustrates LC50 of phosmet (wettable powder formulation); and

FIG. 2 illustrates LC50 of phosmet formulation of the present disclosure.

### DETAILED DESCRIPTION

The present disclosure is further described in light of the following non-limiting examples which are set forth for illustration purpose only and not to be construed for limiting the scope of the disclosure.

### EXAMPLES

A typical formulation in accordance with this disclosure comprises 22.52 w/w % of phosmet, 1.0 w/w % of Dodecylbenzenesulfonic acid, 23.7 w/w % of Butyrolactone, 12.50 w/w % of diethylene glycol mono butyl ether (butyl carbitol), 29.03 w/w % of block copolymer with 10% ethylene oxide [Synperonic PE L/101], 3.32 w/w % of block copolymer with 40% ethylene oxide [Pluronic PE 10400] and 4.15 w/w % of alcohol ethoxylate with C9 to C11 with 5 moles ethylene oxide [Neodol 91-5].

Said formulation was shown to be physically and chemically stable when stored at extremes of temperature as shown in the Table No. 1.

TABLE NO. 1

| | w/w % | % change in | |
|---|---|---|---|
| Particulars | phosmet | phosmet | Physical appearance |
| Initial | 22.52 | NA | Clear amber liquid |
| 2 weeks @ 54° C. | 22.51 | −0.04 | No change |
| 2 weeks @ 5° C. | 22.83 | 1.38 | No change |
| Freeze thaw (5 times) | — | — | No change |

### Example 1

The relative effect of pesticidal formulation of the present disclosure was studied for controlling Navel orange worm on sweet almond:

The test solutions were prepared with the final mixed volume to 0.5 liter. Twenty 5×5 cm² petri dishes were set up for each treatment and approximately 10 mg of sweet almond based artificial diet for navel orange worm was placed on each dish and 10 micro liter (application volume is 100 gal/acre) of the test solution was inoculated into the diet using micropipette. Then two second instar navel orange worms were introduced per petri dish. All petri dishes after introduction of navel orange worms were covered with the lid. The petri dishes were left in the laboratory at a temperature of 25+/−2° C. which were exposed to light for 12 hours and kept in the dark for twelve hours. Mortality of navel orange worm was evaluated after 3 days and 7 days of treatment. The mean mortality results obtained are provided herein Table No. 2.

TABLE NO. 2

| | | | Mean mortality | |
|---|---|---|---|---|
| | | Rate of | of navel orange | |
| | | the active | worm after | |
| Treatment | Treatment | ingredient | treatment | |
| No. | Name | in ppm | 3 days | 7 days |
| 1 | UNTREATED | NA | 2.5 | 2.5 |
| | CHECK | | | |
| 2 | PHOSMET | 1000 | 55.0 | 65.0 |
| | (WETTABLE | | | |
| | POWDER | | | |
| | FORMULATION) | | | |
| 3 | PHOSMET | 500 | 37.5 | 42.5 |
| | (WETTABLE | | | |
| | POWDER | | | |
| | FORMULATION) | | | |
| 4 | PHOSMET | 300 | 27.5 | 37.5 |
| | (WETTABLE | | | |
| | POWDER | | | |
| | FORMULATION) | | | |
| 5 | PHOSMET | 100 | 15.0 | 20.0 |
| | (WETTABLE | | | |
| | POWDER | | | |
| | FORMULATION) | | | |
| 6 | PHOSMET | 1000 | 85.0 | 95.0 |
| | FORMULATION | | | |
| | OF THE | | | |
| | PRESENT | | | |
| | DISCLOSURE | | | |
| 7 | PHOSMET | 500 | 47.5 | 67.5 |
| | FORMULATION | | | |
| | OF THE | | | |
| | PRESENT | | | |
| | DISCLOSURE | | | |
| 8 | PHOSMET | 300 | 42.5 | 47.5 |
| | FORMULATION | | | |
| | OF THE | | | |
| | PRESENT | | | |
| | DISCLOSURE | | | |
| 9 | PHOSMET | 100 | 22.5 | 40.0 |
| | FORMULATION | | | |
| | OF THE | | | |
| | PRESENT | | | |
| | DISCLOSURE | | | |

| | | |
|---|---|---|
| LSD (P = .05) | 17.37 | 15.10 |
| Standard Deviation | 28.02 | 24.36 |
| CV | 78.74 | 43.37 |
| Bartlett's X2 | 39.023 | 56.997 |
| P (Bartlett's X2) | 0.001 | 0.001 |
| Replicate F | 0.925 | 1.093 |
| Replicate Prob(F) | 0.5526 | 0.3570 |
| Treatment F | 12.885 | 28.357 |
| Treatment Prob(F) | 0.0001 | 0.0001 |

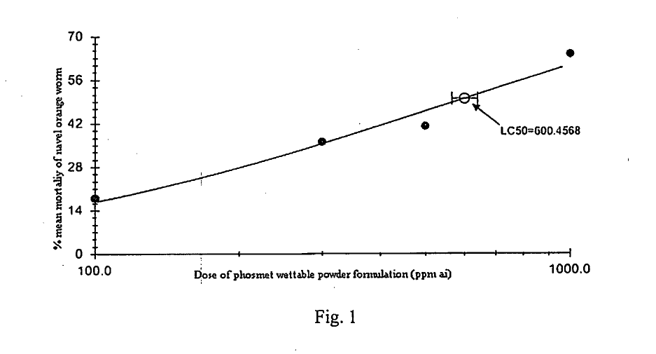

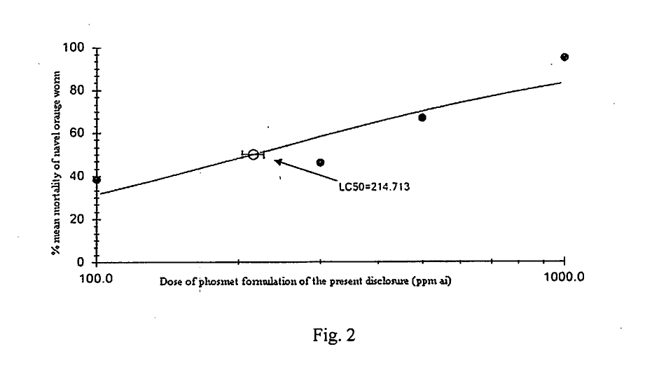

To determine LC50 (lethal concentration required to kill half of the navel orange worm population) of each formulation the graphs were plotted using the mean mortality of navel orange worm after seven days, Accordingly, FIG. 1 illustrates LC50 of phosmet (wettable powder formulation) and FIG. 2 illustrates LC50 of phosmet formulation of the present disclosure.

TABLE 3
Calculation table of LC50 of phosmet (wettable powder formulation)

| X = log(d) | d | n | r | p | Y | w | nw | nwX |
|---|---|---|---|---|---|---|---|---|
| | | 2000 | 50 | 0.025 | | | | |
| 3.0 | 1000.0001 | 2000 | 1300 | 0.641 | 5.36 | 0.6072 | 1214.4653 | 6000.0011 |
| 2.699 | 500.0001 | 2000 | 850 | 0.4103 | 4.7743 | 0.6249 | 1249.8578 | 5397.9405 |
| 2.4771 | 300.0 | 2000 | 750 | 0.359 | 4.6388 | 0.607 | 1214.0961 | 4954.2432 |
| 2.0 | 100.0 | 2000 | 400 | 0.1795 | 4.0833 | 0.4661 | 932.1073 | 4000.0004 |
| | | | | | | | 4610.5263 | 11888.4035 |
| | | | | X = log(d) | nwY | nwXX | nwYY | nwXY |
| | | | | 3.0 | 36000007.6 | 10722.4044 | 114969947.497 | 32167.2161 |
| | | | | 2.699 | 29137758.9138 | 9546.2304 | 91130505.113 | 25764.9909 |
| | | | | 2.4771 | 24544522.4545 | 9277.5976 | 86073808.6074 | 22981.7347 |
| | | | | 2.0 | 16000001.6 | 8165.3582 | 66673066.6673 | 16330.7165 |
| | | | | | 31212.9836 | 21914.8030 | 105047.6433 | 57197.2049 |

X=log Dose, d=Dose, n=Sample, r=Response, p=Percent, Y=Probit w=Weighting Coefficient, nw, nwX, nwXX, nwY, nwYY, nwXY=Calculation Table

The CHI-SQUARE value is 31.4060
The slope of the probit line is 1.2343
The intercept of the probit line is 1.5706
The equation is Y=1.5706+1.2343X

### ln LC50=2.7785

### LC50=600.4568

95% confidence limits for LC50=(565.3799,640.3797).

TABLE 4
Calculation table of LC50 of phosmet formulation of the present disclosure

| X = log(d) | d | n | r | p | Y | w | nw | nwX |
|---|---|---|---|---|---|---|---|---|
| | | 2000 | 50 | 0.025 | | | | |
| 3.0 | 1000.0001 | 2000 | 1900 | 0.9487 | 6.5496 | 0.2532 | 506.4363 | 6000.0011 |
| 2.699 | 500.0001 | 2000 | 1350 | 0.6667 | 5.4068 | 0.5993 | 1198.6326 | 5397.9405 |
| 2.4771 | 300.0 | 2000 | 950 | 0.4615 | 4.8905 | 0.6339 | 1267.7053 | 4954.2432 |
| 2.0 | 100.0 | 2000 | 800 | 0.3846 | 4.7275 | 0.6196 | 1239.2791 | 4000.0004 |
| | | | | | | | 4212.0532 | 10373.2003 |
| | | | | X = log(d) | nwY | nwXX | nwYY | nwXY |
| | | | | 3.0 | 36000007.6 | 13265.098 | 175962801.5963 | 39795.2969 |
| | | | | 2.699 | 29137758.9138 | 10861.4562 | 117971219.7971 | 29314.7451 |
| | | | | 2.4771 | 24544522.4545 | 9806.8838 | 96174961.6175 | 24292.8423 |
| | | | | 2.0 | 16000001.6 | 9413.2382 | 88609048.8609 | 18826.4765 |
| | | | | | 26025.2135 | 21856.1565 | 114781.9412 | 54517.1656 |

X=log Dose, d=Dose, n=Sample, r=Response, p=Percent, Y=Probit w=Weighting Coefficient, nw, nwX, nwXX, nwY, nwYY, nwXY=Calculation Table

The CHI-SQUARE value is 373.5936
The slope of the probit line is 1.4437
The intercept of the probit line is 1.6335
The equation is Y=1.6335+1.4437X

### ln LC50=2.3319

### LC50=214.7130

95% confidence limits for LC50=(203.6402,225.8611)

From the graphs i.e., FIG. 1 and FIG. 2 it can be concluded that phosmet formulation of the present disclosure is three times more efficacious than the presently commercially available phosmet (wettable powder formulation).

### Example 2

The relative effect of pesticidal formulation of the present disclosure was studied for controlling Alfalfa weevil on Alfalfa:

To study the effect of formulation of the present disclosure, four 10×20 sq.ft plots of Alfalfa were set up for each treatment and 20 gal/acre test solution was sprayed with hand sprayer. Then 10 stems of Alfalfa per replication were collected randomly after 4 days and 7 days of treatment. The stems so collected were shaken into 1 gal white container. The evaluation results obtained are provided herein Table No. 5.

TABLE NO. 5

| | | | Alfalfa weevil | |
|---|---|---|---|---|
| | | Weight of | larvae/10 stems | |
| | | active | (Mean ± SE) | |
| | | ingredient | (4 Days | (7 Days |
| | | in lb per | after | after |
| No. | Treatment/Product Name | acre) | treatment) | treatment) |
| 1 | UNTREATED | NA | 7.5 ± 1.0 | 4.3 ± 0.6 |
| 2 | Beta- CYFLUTHRIN | 0.022 | 0.3 ± 0.3 | 0.0 ± 0.0 |
| 3 | PHOSMET (WETTABLE | 0.93 | 0.5 ± 0.3 | 0.0 ± 0.0 |
| | POWDER FORMULATION) | | | |
| 4 | PHOSMET FORMULATION | 0.47 | 0.5 ± 0.3 | 0.0 ± 0.0 |
| | OF THE PRESENT | | | |
| | DISCLOSURE | | | |
| 5 | PHOSMET FORMULATION | 0.31 | 0.5 ± 0.3 | 0.0 ± 0.0 |
| | OF THE PRESENT | | | |
| | DISCLOSURE | | | |
| 6 | PHOSMET FORMULATION | 0.23 | 2.0 ± 0.0 | 0.0 ± 0.0 |
| | OF THE PRESENT | | | |
| | DISCLOSURE | | | |
| 7 | PHOSMET FORMULATION | 0.31 | 0.5 ± 0.3 | 0.0 ± 0.0 |
| | OF THE PRESENT | | | |
| | DISCLOSURE | | | |

It was observed that Treatment No. 5 PHOSMET FORMULATION OF THE PRESENT DISCLOSURE (0.31 lb of the active ingredient/acre) and Treatment No. 3 PHOSMET (WETTABLE POWDER FORMULATION) (0.93 lb of the active ingredient/acre) kill the same quantity of Alfalfa weevil larvae. This indicates that phosmet formulation of the present disclosure is three times more efficacious than phosmet wettable powder formulation presently available in the market.

### Example 3

The relative effect of pesticidal formulation of the present disclosure was studied for controlling psyllid on Citrus.

Three trees per treatment were sprayed to the point of run off. When the plants dried off, 3 leave per tree were cut to fit a 16×50 mm petri dish. 10 adults were transferred into each dish and mortality recorded over 72 hrs. The evaluation results obtained are provided herein Table No. 6.

TABLE NO. 6

| | | Weight of | | | | |
|---|---|---|---|---|---|---|
| | | active | | | | |
| Treatment | | ingredient | | % Mortality of Psyllid | | |
| No. | Treatment | in oz | Buffer | 24 Hrs | 48 Hrs | 72 Hrs |
| 1 | PHOSMET(WETTABLE | 16 | Yes | 28 | 62 | 100 |
| | POWDER | | | | | |
| | FORMULATION) | | | | | |
| 2 | PHOSMET | 8 | Yes | 30 | 82 | 96 |
| | FORMULATION OF THE | | | | | |
| | PRESENT DISCLOSURE | | | | | |
| 3 | PHOSMET | 16 | Yes | 57 | 90 | 100 |
| | FORMULATION OF THE | | | | | |
| | PRESENT DISCLOSURE | | | | | |
| 4 | PHOSMET | 32 | Yes | 80 | 97 | 100 |
| | FORMULATION OF THE | | | | | |
| | PRESENT DISCLOSURE | | | | | |
| 5 | PHOSMET(WETTABLE | 16 | No | 23 | 96 | 100 |
| | POWDER | | | | | |
| | FORMULATION) | | | | | |
| 6 | PHOSMET | 8 | No | 73 | 97 | 100 |
| | FORMULATION OF THE | | | | | |
| | PRESENT DISCLOSURE | | | | | |
| 7 | PHOSMET | 16 | No | 73 | 100 | 100 |
| | FORMULATION OF THE | | | | | |
| | PRESENT DISCLOSURE | | | | | |
| 8 | PHOSMET | 32 oz | No | 77 | 100 | 100 |
| | FORMULATION OF THE | | | | | |
| | PRESENT DISCLOSURE | | | | | |
| 9 | CONTROL | — | — | 7 | 23 | 40 |

It was observed that phosmet formulation) of the present disclosure (2.24 oz of the active ingredient/acre (8 oz. formulation) is more efficacious than phosmet wettable powder formulation presently available in the market (11.2 oz of the active ingredient/acre (16 oz. formulated)).

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

The use of the expression “at least” or “at least one” suggests the use of one or more elements or ingredients or quantities, as the use may be in the embodiment of the invention to achieve one or more of the desired objects or results.

The numerical values given for various physical parameters, dimensions and quantities are only approximate values and it is envisaged that the values higher than the numerical value assigned to the physical parameters, dimensions and quantities fall within the scope of the disclosure and the claims unless there is a statement in the specification to the contrary.

While certain embodiments of the inventions have been described, these embodiments have been presented by way of example only, and are not intended to limit the scope of the disclosure. Variations or modifications in the formulation or combination of this invention, within the scope of the disclosure, may occur to those skilled in the art upon reviewing the disclosure herein. Such variations or modifications are well within the spirit of this disclosure. The accompanying claims and their equivalents are intended to cover such forms or modifications as would fall within the scope and spirit of the disclosure.

We claim:

1. A pesticidal formulation comprising:
i. At least one pesticide, typically an organophosphate compound in an amount between 5.0% w/w and 40.0% w/w, preferably between 15.0% w/w and 30.0% w/w,
ii. Solvent system comprising at least one glycol ether and at least one lactone in an amount between 10.0% to 80.0% w/w, preferably between 30.0% w/w and 55% w/w, with ratio of the glycol ether and the lactone is the in the range of 1:9 and 9:1, preferably in the range of 2:8 and 4:6,
iii. Surfactant system containing at least two nonionic surfactants where the primary surfactant has an HLB range of 10 to 20 and the co-surfactant has a HLB range 1 to 5, in an amount ranging between 0.1% w/w to 60.0% w/w preferably in the range of 20.0% w/w to 40.0% w/w, and
iv. At least one excipient in the range of 0.1% w/w to 10% w/w and preferably 0.5% w/w to 5.0% w/w.

2. The formulation as claimed in claim 1, characterized in that said formulation is in the form of a concentrate containing one or more biologically active ingredient(s) which upon dilution spontaneously self-forms a water external nano-emulsion wherein, the particle size of said nano emulsion ranges between 10 to 200 nm.

3. The formulation as claimed in claim 1, wherein said pesticide is at least one selected from the group consisting of algaecide, acaricide, avacide, bactericide, biocide, culicide, fungicide, germicide, gonocide, herbicide, insecticide, larvicide, microbicide, muscicide, nemacide, ovacide, parasiticide, pediculicide, pulicicide, raticide, scabicide, spermicide, teniacide, vermicide, vespacide, virucide and miticide, in an amount ranging between 5.0 w/w % and 40.0 w/w %, preferably between 15.0 w/w % and 30.0 w/w %.

4. The formulation as claimed in claim 1 wherein said pesticide is at least one organophosphate selected from the group consisting of acephate, acethion, acetophos, amiton, amidithion, azamethiphos, azinphos ethyl, azinphos methyl, azothoate, bansulide, bromfenvinfos, bromophos, bromophos-ethyl, butathiofos, carbophenothion, cadusafos, calvinphos, chlorethoxyfos, chlorfenvinphos, chlormephos, chlorpyrifos, chlorpyrifos-methyl, chlorthiophos, chlorphoxim, colophonate, coumaphos, coumithoate, crotoxyphos, cyanophos, cyanthoate, demephion-O, demephion-S, demeton-O, demeton-S, demeton-methyl, demeton-O-methyl, demeton-S-methyl, demeton-S-methylsulphon, dichlorvos, dialifos, diazinon, dicapthon, dichlofenthion, dicrotophos, dimethoate, dimethylvinphos, dioxathion, dioxabenzofos, disulfoton, dithicrofos, endothion, etaphos, ethion, ethoprop, ethyl-parathion, ethoate-methyl, etrimfos, famphur, fenchlorphos, fenamiphos, fenitrothion, fensulfothion, fenthion, fenthion-ethyl, fonofos, fospirate, formothion, heptenophos, heterophos, isazophos, isofenphos, isoxathion, S-ethylsulfinylmethyl O,O-diisopropylphosphorodithioate, isothioate, jodfenphos, lirimfos, malathion, mecarbam, mesulfenfos, menazon, methacrifos, methylacetophos, methamidophos, methidathion, methyl-parathion, mevinphos, methocrotophos, monocrotophos, morphothion, naled, naftalofos, oxydemeton-methyl, omethoate, parathion, pirimiphos-ethyl, pirimiphos-methyl, phenthoate, phenkapton, phosnichlor, phorate, phosalone, phosmet, phosphamidon, phostebupirim, phoxim, phoxim-methyl, primidophos, profenofos, propaphos, propetamphos, prothiofos, prothoate, pyraclofos, pyrazophos, pyrazothion, pyridaphenthion, pyrimitate, quinothion, quinalphos, quinalphos-methyl, oxydemeton-methyl, oxydeprofos, oxydisulfoton, sophamide, sulfotep, sulprofos, tebupirimfos, temephos, terbufos, tetrachlorvinphos, tetraethyl pyrophosphate, thicrofos, thiometon, trifenofos, vamidothion, xiaochongliulin, zolaprofos, preferably phosmet.

5. The formulation as claimed in claim 1, wherein the nonionic surfactant is at least two selected from the group consisting of ethoxylated alcohols, ethoxylated fatty acid ester, alkoxy block copolymers, alkylpolyglycosides, alkoxylated alkanolaminedes, amine oxide selected from the group consisting of alkyl di(lower alkyl) amine oxides, alkyl di(hydroxy lower alkyl) amine oxides, alkylamidopropyl di(lower alkyl) amine oxides and alkylmorpholine oxides, in an amount ranging between 0.1% w/w and 60.0% w/w, preferably 20.0% w/w and 40.0% w/w.

6. The formulation as claimed in claim 5, where in ethoxylated alcohol is selected from one containing C9 to C15 and 3 to 20 moles ethylene oxide in an amount containing between 0.2% w/w and 20.0% w/w, preferably 0.5% w/w and 10.0% w/w.

7. The formulation as claimed in claim 5, wherein said ethoxylated fatty acid ester is based on ester of sorbitol and fatty acid C10 to C18 with 3 to 25 moles of ethylene oxide.

8. The formulation as claimed in claim 5, wherein said alkoxy block copolymer is at least one selected from the group consisting of ethoxy/propoxy block copolymers and ethoxy/butoxy block copolymers, preferably ethoxy/propoxy block copolymer containing 10.0% to 80.0% ethylene oxide with a propylene oxide backbone of molecular weight of 950 to 3750.

9. The formulation as claimed in claim 1, wherein the solvent system further comprises at least one solvent selected from the group consisting of methanol, ethanol, butanol, propanol, glycols, glycol ether, cyclohexanone, acetone, acetonitrile, isophorone, esters, ketones and lactones.

10. The formulation as claimed in claim 1, wherein the glycol ether is at least one selected from the group consisting of diethylene glycol-n-butyl ether acetate, diethylene glycol mono butyl ether (butyl carbitol), ethylene glycol n-butyl ether acetate, ethylene glycol mono butyl ether, diethylene glycol monoethyl ether, ethylene glycol phenyl ether, triethylene glycol monoethyl ether, diethylene glycol mono hexyl ether, ethylene glycol mono hexyl ether, triethylene glycol mono methyl ether, diethylene glycol mono methyl ether, ethylene glycol mono-n-propyl ether, dipropylene glycol methyl ether, dipropylene glycol methyl ether acetate, dipropylene glycol-n-butyl ether, dipropylene glycol-n-propyl ether, propylene glycol methyl ether, propylene glycol methyl ether acetate, propylene glycol-n-butyl ether, propylene glycol-n-propyl ether, propylene glycol phenyl ether, tripropylene glycol methyl ether, tripropylene glycol-n-butyl ether and dipropylene glycol dimethyl ether.

11. The formulation as claimed in claim 1, wherein the lactone is at least one selected from the group consisting of α-acetolactone, propiolactone, butyrolactone, d-glucono-lactone, caprolactone, δ-valerolactone, C₁ to C₁₀ alkyl substituted linear or branched 3,6-dihydro-2H-Pyran-2-one, 6,7-Dihydro-2(3H)-oxepinone, oxepan-2-one, 2-oxocanone, 2-oxonanone and oxecan-2-one.

12. The formulation as claimed in claim 1, wherein said excipient is at least one excipient selected from the group consisting of an anionic surfactant, pH modifiers, preservatives, adjuvants, antifreezes, oils, waxes, thickening agents (gelling agent), emollients, alkalizing agents, acidifying agents, perfumes, binding agents, defoamers, stabilizing agents, dispersing agents, wetting agents, colorants, plant growth regulators and emulsifiers, in a range between 0.1% w/w and 10.0% w/w, preferably 0.5% and 5.0%.

13. The formulation as claimed in claim 12, wherein the anionic surfactant is at least one selected from the group consisting of alkali metal salts, ammonium salts, amine salts, and amino alcohol salts of at least one selected from the group consisting of (linear and secondary) alcohol sulfates and sulfonates, alcohol phosphates and phosphonates, alkyl sulfates, alkyl ether sulfates, sulfate esters of an alkylphenoxy polyoxyethylene ethanol, alkyl monoglyceride sulfates, alkyl sulfonates, olefin sulfonates, paraffin sulfonates, beta-alkoxy alkane sulfonates, alkylamidoether sulfates, alkylaryl polyether sulfates, monoglyceride sulfates, alkyl ether sulfonates, ethoxylated alkyl sulfonates, alkylaryl sulfonates, alkyl benzene sulfonates, alkyl benzene sulfonic acids, alkylamide sulfonates, alkyl monoglyceride sulfonates, alkyl carboxylates, alkyl sulfoacetates, alkyl ether carboxylates, alkyl alkoxy carboxylates having 1 to 5 moles of ethylene oxide, alkyl sulfosuccinates, alkyl ether sulfosuccinates, alkylamide sulfosuccinates, alkyl sulfosuccinamates, octoxynol or nonoxynol phosphates, alkyl phosphates, alkyl ether phosphates, taurates, N-acyl taurates, fatty taurides, fatty acid amide polyoxyethylene sulfates, isethionates, acyl isethionates, and sarcosinates and acyl sarcosinates preferably, alkyl benzene sulfonates represented by a Formula (I) and alkyl benzene sulfonic acids; 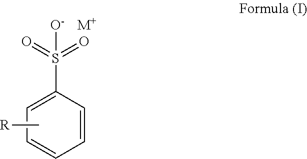
wherein, R is a linear or branched, substituted or unsubstituted, aliphatic or aromatic C₈ to C₁₈ carbon atoms, preferably dodecyl, and
M is a cation selected from the group consisting of alkali metal, ammonium, amine and amino alcohol,
in an amount ranging between 0.1 w/w % and 10.0 w/w %, preferably 0.5 w/w % and 5.0 w/w %.

14. The formulation as claimed in claim 1, wherein said formulation comprises 22.0 to 27.0 w/w % of phosmet, 1.0 w/w % of Dodecylbenzenesulfonic acid, 23.0 to 25 w/w % of Butyrolactone, 12.50 w/w % of diethylene glycol mono butyl ether (butyl carbitol), 29.03 w/w % of block copolymer with 10% ethylene oxide [Synperonic PE L/101], 3.32 w/w % of block copolymer with 40% ethylene oxide [Pluronic PE 10400] and 4.15 w/w % of alcohol ethoxylate with C9 to C11 with 5 moles ethylene oxide [Neodol 91-5].

15. Use of the pesticidal formulation as claimed in claim 1, for controlling a wide variety of insect pests on crops, vegetables, fruits, nuts, turfs, ornamental plants, perennial plants, annuals plants selected from the group consisting of pome fruits which include pear, apple, crabapple, loquat, mayhaw and quince, stone fruits which include apricots, cherries, nectarines, peaches, plums, plum cot and prune, olive, canola which include oilseed rape, citrus fruits which include orange, grapefruit, lemon, line and tangerine, bush berries, blueberries, cranberries, potatoes and sweet potatoes, tree nuts which include almonds, sweet almonds, beechnut, brazil nut, butternut, cashew nut, chinquapin, filbert (hazelnut), hickory, macadamia, pecan, pistachio and walnut, alfalfa, grapes, tomato, lettuce, onion, bulb vegetables, cote crops, cucurbits, legume vegetables, root and tuber vegetables, cereal grain, cotton, herbs and tobacco.

16. Use of the pesticidal formulation as claimed in claim 1, in controlling at least one pest selected from the group consisting of alfalfa weevil, apple maggot, banded grape bug, black pecan aphid, blueberry maggot, cherry fruit flies, codling moth, Colorado potato beetle, dock sawfly, elm spanworm, European corn borer, European sawfly, fire worms, fruit worms, grape berry moth, grape cane borer, grape leaf folder, green fruit worm, gypsy moth, hickory shuck worm, Japanese beetle, leafhoppers, leaf roller, lygocoris bug, mealy bug, navel orange worm, orange tortix, oriental fruit moth, peach twig borer, pecan nut casebearer, pine tip moth, plum curculio, red humped caterpillar, rose chafer, sawfly, scale, spanworm, spotted wing drosophila, strawberry root weevil adult, syneta beetle, walnut husk fly, weevil, western grape leaf skeletonizer, western tussock moth, black cherry aphid, mites, pear psylla, aphids, white fly, thrips and asian citrus psyllid.

17. A method of controlling a pest selected from the group consisting of alfalfa weevil, apple maggot, banded grape bug, black pecan aphid, blueberry maggot, cherry fruit flies, codling moth, Colorado potato beetle, dock sawfly, elm spanworm, European corn borer, European sawfly, fire worms, fruit worms, grape berry moth, grape cane borer, grape leaf folder, green fruit worm, gypsy moth, hickory shuck worm, Japanese beetle, leafhoppers, leaf roller, lygocoris bug, mealy bug, navel orange worm, orange tortix, oriental fruit moth, peach twig borer, pecan nut casebearer, pine tip moth, plum curculio, red humped caterpillar, rose chafer, sawfly, scale, spanworm, spotted wing drosophila, strawberry root weevil adult, syneta beetle, walnut husk fly, weevil, western grape leaf skeletonizer, western tussock moth, black cherry aphid, mites, pear psylla, aphids, white fly, thrips and asian citrus psyllid, said method comprising the step of applying the pesticidal formulation of claim 1 and optionally, water, using at least one technique selected from the group consisting of spraying, pouring, dipping, rubbing, air-blasting, mist-blowing and oiling to an area infected by said pest.
